(19) United States
(12) Patent Application Publication
(10) Pub. No.: US 2005/0179541 A1
(43) Pub. Date: Aug. 18, 2005

(54) Personal property security device

(75) Inventor: Daniel G. Wolfe, Highland, UT (US)

Correspondence Address: Harrison Colter, Suite 310, 333 South 520 West, Lindon, UT, 84042, US

(73) Assignee: Red Wolf Technologies, Inc., Highland, UT (US)

(21) Appl. No.: 11/090,668

(22) Filed: Mar. 22, 2005

Related U.S. Application Data
(63) Continuation-in-part of application No. 10/738,437, filed on Dec. 17, 2003.
Application No. 10/738,437 is a continuation-in-part of application No. 10/636,348, filed on Aug. 7, 2003.
Application No. 10/636,348 is a continuation-in-part of application No. 09/943,913, filed on Aug. 31, 2001, now Pat. No. 6,700,762.

(51) Int. Cl. G08B 1/08

(52) U.S. Cl. 340/539.22; 340/539.13

(57) ABSTRACT

A mobile monitoring device that may be used to increase the security of property is disclosed. The monitoring device includes a controller and a transceiver that is in electronic communication with the controller. The transceiver is capable of communicating with a computing device. At least one sensor is also added to the monitoring device. The sensor is in electronic communication with the controller and is designed such that it is capable of detecting a change in a condition of the property being monitored. The monitoring device is also designed such that it may execute programming commands received from the computing device. The monitoring device is also designed to be track-able by various methods.

### CROSS REFERENCE TO RELATED APPLICATION

This application is a continuation-in-part of U.S. patent application Ser. No. 10/738,437, filed Dec. 17, 2003, which is a continuation-in-part of U.S. patent application Ser. No. 10/636,348 filed Aug. 7, 2003, which is a continuation-in-part of U.S. patent application Ser. No. 09/943,913 filed Aug. 31, 2001, now U.S. Pat. No. 6,864,789.” These prior applications are incorporated herein by reference.

### BACKGROUND OF THE INVENTION

The present invention relates to novel systems and methods for providing personal property security. More specifically the present invention relates to a device for providing automated notice of disturbances to personal property and automated tracking of movement of the personal property and to a method and system for remotely managing the device.

Many personal, corporate or government property items of all types are vulnerable to theft and vandalism with no effective or economical means of protecting them. Monitored security systems are seldom effective and usually expensive. Such monitored security systems are also not mobile and are slow to respond to trouble. Thieves and vandals of small items are seldom caught, and the personal property is seldom recovered. The police are frustrated and often ineffective in recovering stolen personal property.

What is needed is a device for securing personal property that is portable, simple, inconspicuous, effective, and economical and that can be managed remotely, inexpensively and efficiently. Such a device may be highly effective in providing notification of disturbances to personal property and may be sufficiently economical to be purchased by a wide cross-section of consumers. Such a device may inconspicuously protect a wide array of personal property, including vehicles, power tools, bicycles, trailers, boats, stereos, and televisions. Such a device may be manageable remotely through various access and management mechanisms including by means of computers and communications and data networks. Upon disturbance of personal property, such a device might be effective to provide notification of the disturbance and provide tracking information regarding any movement of the personal property to enable identification and apprehension of the perpetrator(s) and enable quick recovery of the property.

### SUMMARY OF THE INVENTION

The security system of the present invention allows a user to develop a security monitoring system for securing or monitoring personal property without subscribing to a security monitoring company or undertaking rigorous installation of sensors and infrastructure. In addition, the security system of the present invention allows a user to augment the personal property protection system by interfacing the system with communications and data networks. The present invention allows a user to (i) purchase or otherwise procure a security module that couples to a cellular or other wireless transceiver and is operational over generally available wireless communications and data networks, (ii) attach or have attached the security device (e.g., security module and wireless transceiver, or alternatively, an integrated composition of both functionalities) to personal property or even to a person, (iii) activate a detection sensor within the security module either through direct interaction with the security module or through a communications or data network, and (iv) upon triggering of an alarm, the security module initiates a dialing command to the wireless transceiver, which either executes a dialing command received from the security module or employs a preprogrammed dialing string within the wireless transceiver to establish a communication link with the user telephone over a wireless (e.g., cellular, PCS, satellite, etc.) network directly to the user by means of the communication link or indirectly to the user through a computer processing application and interface.

The user receives a call from the security device directly by the communications link, or receives an alert or other notification, either spontaneously or as a result of a query by the user, through a communications or data network. Depending on the information transmitted in the call, the user may evaluate the legitimacy of the alarm state by various means, including listening to audible sounds originating in the proximity of the security device, or monitoring the sensors of the security device through communications interfaces, including an Internet web or voice interface. The user may also employ optional interrogation sensors (e.g., imagery, infrared, motion, temperature, etc.) located about the security device to further legitimize the alarm state.

Once an alarm has been verified, a location identifier within the security device may be activated to enable tracking of the personal property by the user. Tracking may activated by the user initiating a decodable keypad sequence recognized by the security device, or by a computer program or data or voice communications protocol decodable by the device, or activation may be time delayed or even immediate upon detection of an alarm condition. Tracking may assume one of several approaches, such as a transmitting beacon located within the security device that may be detected by a tracking receiver used by the user, or a receiving location-based system (e.g., a global positioning satellite or GPS unit) that allows the coordinates of the security device to be determined and forwarded to the user over the communication link.

The apparatus of the present invention has been developed in response to the present state of the art, and in particular in response to the problems and needs in the art that have not yet been fully solved by currently available personal property security devices and systems. Thus, the present invention provides a personal property security device for use with personal property without the problems described above. These and other features and advantages of the present invention will become more fully apparent from the following description, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an exemplary environment and configuration, in accordance with the preferred embodiment of the present invention;

FIG. 2 illustrates a block diagram of the security system, in accordance with the preferred embodiment of the present invention;

FIG. 3 illustrates a detailed block diagram of the security device in accordance with a preferred embodiment of the present invention;

FIG. 4 is a flow diagram of the security methods implemented by the device, in accordance with the preferred embodiment of the present invention;

FIG. 5 is a flow diagram of a monitoring method, in accordance with a preferred embodiment of the present invention; and

FIG. 6 is a mechanical embodiment of an integrated transceiver and a security module, in accordance with an embodiment of the present invention.

### DETAILED DESCRIPTION

It will be readily understood that the components and systems of the present invention, as generally described and illustrated in the Figures herein, could be arranged and designed in a wide variety of different configurations. Thus, the following more detailed description of the embodiments of the system and method of the present invention, as represented in the Figures, is not intended to limit the scope of the invention. The scope of the invention is as broad as claimed. The illustrations are merely representative of certain embodiments of the invention. Those embodiments of the invention may best be understood by reference to the drawings, wherein like parts are designated by like numerals throughout.

Those of ordinary skill in the art will appreciate that various modifications to the details of the Figures may made without departing from the essential characteristics of the invention. Thus, the following description of the Figures is intended only by way of example, and illustrates certain embodiments consistent with the invention as claimed.

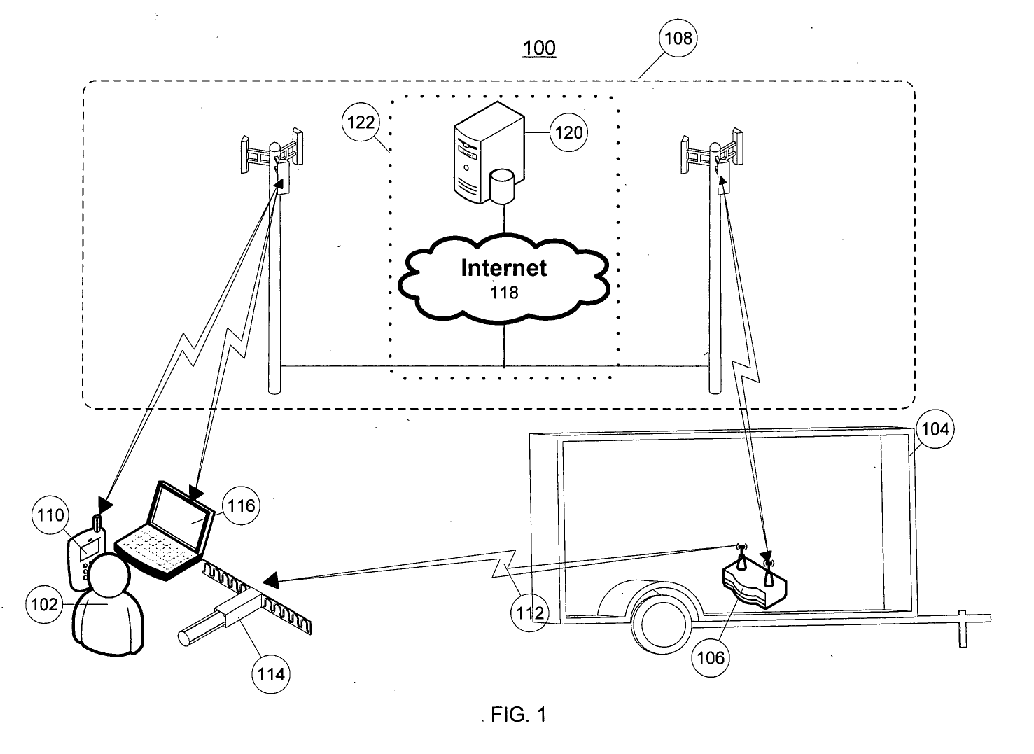

FIG. 1 illustrates a system 100 for securing personal property and detecting and tracking an unauthorized or unanticipated intrusion or removal of personal property. As illustrated, a user 102 desires to secure a personal property asset 104, which may be of various forms including mobile assets, stationary assets, or other types of property whose status and/or location may be of interest to user 102. The present invention facilitates the monitoring of such assets through the inclusion of a security device 106 within the confines or surroundings of personal property 104. A user activates security device 106 to monitor or be aware of surroundings about security device 106 by interacting physically with the security device 106, through a user transceiver 110 by initiating a communication link through a communication network 108 or through a computing device 116, which may be of various forms, including a personal computer or personal digital assistant, connected to a communication network 108.

Upon the triggering or happening of certain events or conditions, the security device 106 autonomously contacts the user 102 by initiating a communication link through a communication network 108 to a user transceiver 110 or a computing device 116. Upon such notification, the user 102 may perceive audible and/or other surroundings about the security device 106 including information prepared and delivered by the security device 106 to the user transceiver 110 or the computing device 116. The user 102 may respond to such information in various manners. The user 102 may evaluate audible sounds and determine whether such audible information necessitates further reactions such as notifying proper authorities or if the personal property 104 has been removed to another location, identifying such location either through the use of the detection of a tracking signal 112 emanating from the security device 106 through the use of a tracking receiver 114 or through the evaluation of other packaged location information dispatched from the security device 106 either through a separate communication channel or through the communication network 108 to the user transceiver 110 or the computing device 116.

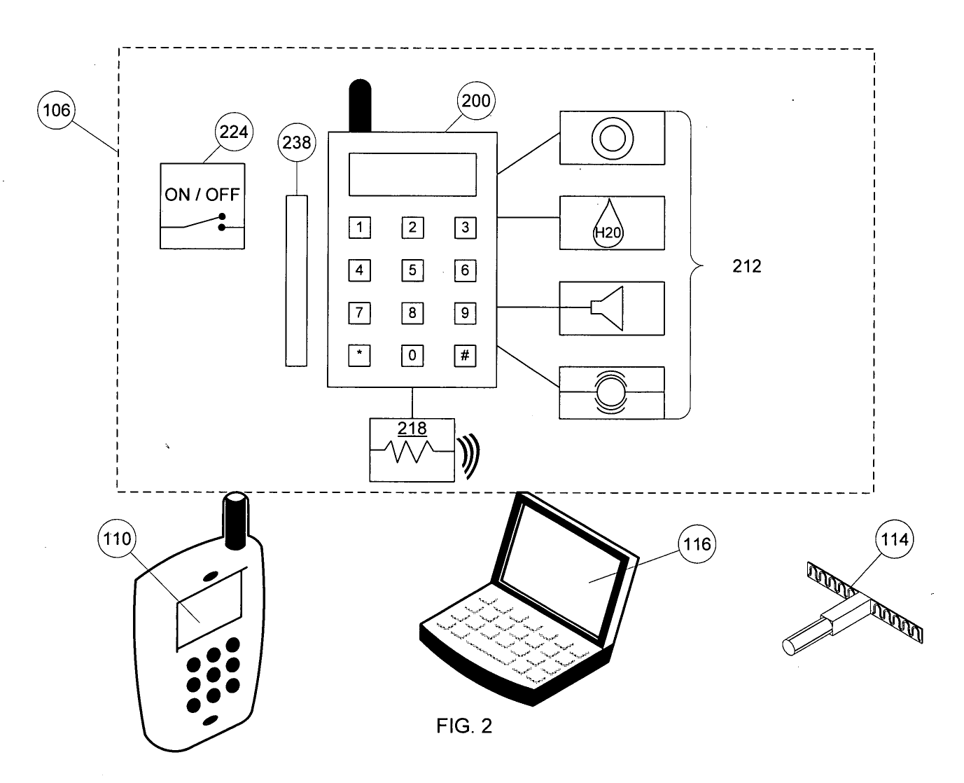

Referring now to FIG. 2, a personal property security device “PPSD” or “security device,” in one embodiment, may include a combination of several electronic devices. The security device may include a digital and/or analog cellular transceiver 200. The transceiver 200 may be used for several purposes. First, the transceiver 200 may be configured to be activated and deactivated by means of a remote transmission from the user transceiver 110 or from the computing device 116. In selected embodiments, a special switch may be installed to activate and deactivate the transceiver 200. Once activated, the transceiver 200 is in a mode ready to call-out to a pre-programmed number (typically corresponding to the cellular telephone of the owner of the personal property or another number designated by the owner) or to communicate with a computing device to provide notification of a disturbance to the personal property.

In one embodiment of the present invention, when the transceiver 200 receives a disturbance signal from a triggering device or detection sensor 212, the transceiver 200 automatically initiates a connection to a computing device 116 and remains on and in the transmitting mode. The computing device may recognize where the communication originated via a device address, readily known caller identification system or global positioning data, as may be obtained from the Global Positioning System (“GPS”) provided by the transceiver 200. The user 102 may also listen to the audio data transmitted by the transceiver 200 to detect noises corresponding to activity in the vicinity of the security device 106. The user may be able to determine from the sounds in the area of the security device whether the signal was a false alarm or whether the security device 106 has initiated communication because of attempted theft, vandalism, or other trouble.

As shown in FIG. 2, the transceiver 200 or detection sensors 212 may be connected to an on/off or activation switch 224 that can be activated by means of a data communication received from the computing device 116 or the like. The activation switch 224 may be designed to receive a coded signal from the computing device 116. When the activation switch 224 recognizes the coded signal, it may cause other parts of the security device 106 to be activated or deactivated as desired. The transceiver 200 may also be connected to other electronic devices such as the devices generally described below.

First, the security device 106 may include a triggering device or detection sensor 212, such as a motion sensor, a shock sensor or the like, and may take several different forms as needed for the specific use of the security device. The detection sensor 212 may take many different forms as the specific need of the security device 106 may dictate and may be activated or deactivated by means of the remotely controlled on/off activation switch 224. In operation, when the security device 106 is activated and in the ready mode, a bump, shock, or jarring, or a movement in the area of the security device may cause the detection sensor 212 to signal the transceiver 200 to initiate communication with computing device 116 in an attempt to request help. In certain embodiments, the detection sensors may be a simple panic button for a lady jogger to use if being attacked, or the detection sensor could be a special switch that detects water to signal a mother when her child who is wearing the security device falls into water or the like.

Second, the security device 106 may include a location identifier 218, which in one embodiment assumes the form of a tracking transmitter. One example of tracking transmitters includes devices similar to tracking devices used to tag and track wildlife or sophisticated receiver-based tracking devices that use GPS. The detection sensors may be configured to activate the location identifier to enable the tracking of movements of the security device. The location identifier is preferably silent in operation.

For an embodiment that includes a tracking transmitter, the tracking transmitter typically emits a silent radio signal that is capable of being tracked by a directional tracking device such as the tracking receiver 114. For example, a simple animal tracking collar has been found to be effective in tracking movements of a security device for distances of several miles to tens of miles or more so long as substantial line of sight between the tracking transmitter and the directional tracking device was maintained. Systems capable of tracking movements of a security device at distances beyond many miles are also currently available. Another tracking embodiment uses a receiver-based location identifier to track movements of the personal property asset. One such embodiment employs the GPS system to track movements. In such an embodiment, the security device 106 relays positioning data to the computing device 116, which may then be used in conjunction with tracking or mapping systems to locate the security device 106.

Third, as depicted in FIG. 2, the security device 106 may include a long life rechargeable battery or power source 238, which typically provides power to the components of the security device 106 that are located with the secured personal property, including the transceiver 200, the on/off or activation switch 224, the triggering or detection sensors 212, and the location identifier 218. The power source 238 is typically as small as possible so that the security device may be inconspicuously attached to personal property and not be too heavy to be worn on a child's belt for such an application. For applications that use a cellular telephone as the transceiver, the power source or battery of the cellular telephone may be used to power the other components of the security device.

As described above, the security system may include a directional tracking receiver 114 in FIG. 2. The tracking receiver 114 is typically a separate device that is kept close at hand by the user of the personal property security device 106, when the security device is in use. For example, a tracking receiver 114 may be attached to a personal property owner's cellular phone, such as the transceiver 200, or to the computing device 116, or may be incorporated into the user's wireless transceiver such that the tracking receiver 114 or computing device 116 and the user transceiver 110 will always be together, when needed.

The tracking receiver 114 may be activated by the user when the security device 106 provides notification of a disturbance to the personal property. The tracking receiver 114 indicates which direction the personal property has been moved. The tracking receiver 114 may be designed to pick up the signal given off by the location identifier (e.g., tracking transmitter) 218. If the user has several security devices, multiple or a single location identifier (e.g., tracking receiver) may be configured to track any of the security devices in use. In embodiments that incorporate GPS technology, a screen on the computing device 116 may display the position of the security device. Typical embodiments of the security devices may be built small and compact enough to be inconspicuous and able to be attached to most anything that a person would want to protect from theft or vandalism, or as the case may be, from other hazards.

Operationally in a digital network embodiment, if the security device 106 is activated and detects a disturbance or is triggered it will automatically send data to the computing system 122. The computing system 122 may comprise a computer network, such as the Internet 118, and an application server 120. The security device 106 when communicating to the computing system 122 may transmit data identifying the security device 106 and alerting the user 102 of a disturbance of the personal property item 104. The user can then determine if he wishes to call the police or respond to the signal himself. The user may decide to go to the location of the item being disturbed and find the thief still in the process of stealing the personal property item 104.

Once triggered, the security device 106 may also transmit to the user via the computing system 122 any sounds that it picks up in its vicinity thereby allowing the user to listen in on what is taking place and help determine if the disturbance is a false alarm. The security device 106 can be totally silent so that the thief may never know that he has been detected. The user can then determine if he wants to call the police or if the disturbance was a false alarm. The security device 106 may also have activated its tracking transmitter when it was disturbed thereby allowing the user, if the personal property had already been removed, to track or follow the security device 106 to its new location. This would allow the user to contact the police and have the thief arrested and the personal property 106 to be recovered.

The security device 106 may have extremely wide application, as it is adaptable to be useful to almost everyone for a wide variety of protection uses. It may assume a small and compact embodiment thereby enabling it to be attached in inconspicuous places where a thief will not likely see it. It can be attached to vehicles, mobile trailers, power tools, bicycles, stereos, TVs, boats, motorcycles, etc. It may even be adapted to be activated with a panic button or water sensor and attached to children or joggers or even old persons, and the like. The security device 106 may facilitate alerting people when a wearer is disturbed or a child has fallen into water such that location may be determined quickly and easily via the tracking capabilities already described. A user 102 of the security device 106 or parent of a child using the device can be more assured of knowing when trouble has occurred and can respond to the exact location of the trouble quickly. A user may desire to use many security devices to monitor the safety and location of several items of personal property in various locations.

Each security device may be designed to transfer a unique identifier to enable a user 102 to determine immediately what personal property or persons are being disturbed or are distressed. The security device 106 may be designed to be small, compact and totally self-contained, making it portable and independent of outside power sources except for the need to be recharged periodically or may draw power from some other source. These features make embodiments of the security device 106 extremely mobile and versatile.

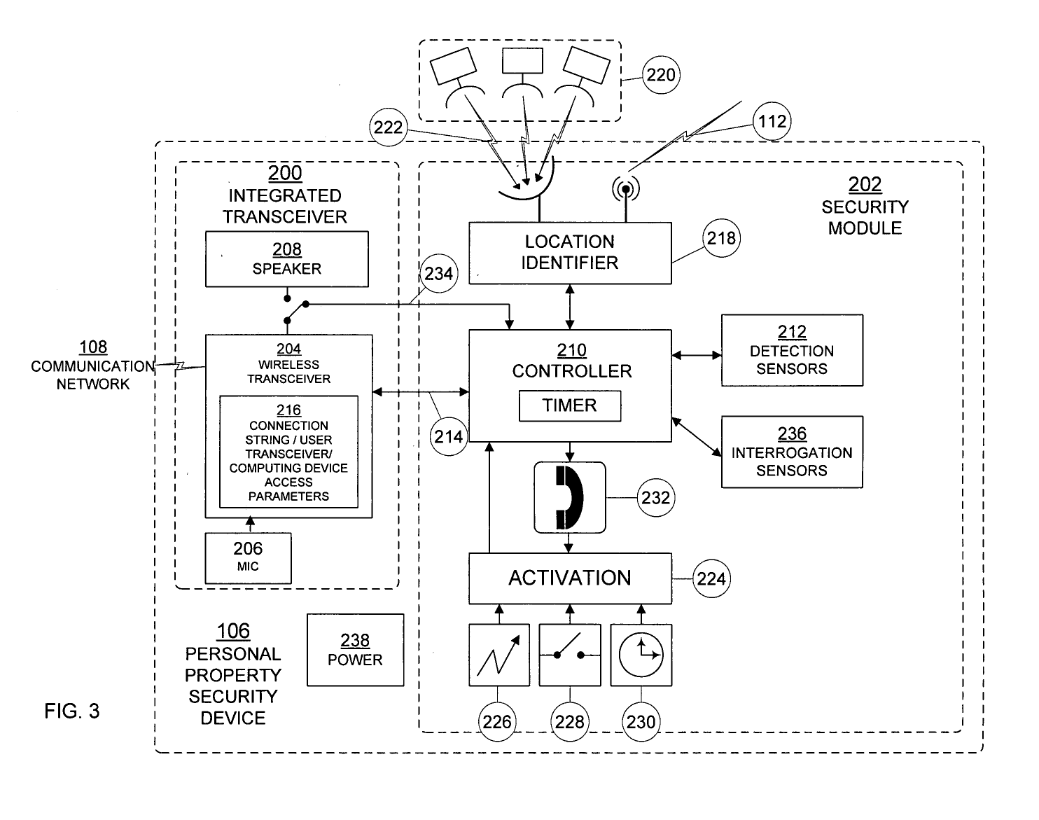

FIG. 3 is a detailed block diagram of a personal property security device 106, in accordance with an embodiment of the invention. For clarity, the security device 106 is partitioned into a transceiver portion for establishing a communication link with a communication network and a security or detection portion for control of sensor devices that either may be triggered or may be interrogated by the user to obtain additional information.

In FIG. 3, the security device 106 is partitioned into a transceiver 200 depicted as an integrated transceiver comprised of a wireless transmitter/receiver 204 and a microphone 206 and speaker 208. Those of skill in the art appreciate that the integrated transceiver 200 may be implemented either as discrete components on a circuit board or in a packaged assembly assuming the form of, for example, a cellular or other similar telephone or radio. The security device 106 is further comprised of a security module 202 for performing evaluation and control of the security device and any accompanying sensors. The security module 202 may interface with transceiver 200 through various means including combined integration of (i) the various components associated with the integrated transceiver 200 with (ii) the various components associated with the security module 202 on a common circuit board or multiple circuit boards. When an integrated transceiver is employed, a convenient interface between the devices may be provided by a data port or other hands-free interfaces commonly associated with integrated transceivers.

The security module 202 is comprised of a controller 210 and detection or triggering sensors 212. The detection sensors 212 may be autonomous sensors that provide an interrupt or other signal to the controller 210 or may be monitored under the direction of the controller 210 and implemented as a peripheral device whose state is monitored by the controller 210. The controller 210 interfaces with the wireless transceiver 204 via an interface 214. Upon the detection of sensor information, the controller 210 may initiate a direct digital data connection using a communications protocol such as the Internet Protocol (“IP”) or may initiate a dialing sequence using the wireless transceiver 204, which causes the wireless transceiver 204 to initiate a call using a preset number or preprogrammed dialing string 216, which may correspond to the routing or phone number of the user transceiver 110 (FIG. 1). Once a communication channel is established, the controller 210 may forward sensor information or may allow audible tones detected by the microphone 206 to be passed via the wireless transceiver 204 to the user transceiver 110 or the computing device 116.

The security module 202 may further comprise a location identifier 218 which may be under the control of the controller 210 or may be autonomous and be activated by the controller 210 or, alternatively, may provide information to the controller 210 in the form of location data. The present invention contemplates at least two embodiments of the location identifier 218. In a first embodiment, the location identifier 218 is implemented as a tracking transmitter or beacon that, when activated, broadcasts a tracking signal 112 that may be detected and located through the use of a tracking receiver 114 (FIG. 1). Such an embodiment is one in which the location identifier 118 assumes a transmitter role.

In an alternate embodiment, the location identifier 218 assumes a receiver role in which the remote location transmitters 220 transmit signals 222 that are received at the location identifier 218 and may be read and provide location data to the controller 210 for forwarding over the communication network 108 (FIG. 1) for evaluation and interpretation by the user transceiver 110 (FIG. 1) or the computing device 116. Such location data may be longitudinal/latitudinal data interpretable by the user 102 (FIG. 1) or other information processable by the user 102 that relates to the location of the security device 106. Those of skill in the art appreciate that the location transmitters 220 may take the form of fixed site or orbiting types of transmitters, with one such embodiment including the GPS system, known by those of skill in the art.

Additional features contemplated by the present invention include activation circuitry 224 that allows the user 102 or another entity, such as the computing system 122 (FIG. 1) to activate the alarming or security features of the security device 106. Exemplary activation implementations contemplated by the inventor include, a remote transmission activation device depicted as a transmitter activation 226, known by those of skill in the art to include devices such as “remote-keyless entry”—like devices, or similar devices known by those of skill in the art, or activation by means of a computing device 116 or a computing system 122. Other such activation devices include switch activated devices 228 including manual push buttons, toggle switches or other switches activated either manually or by the closing of a door or other similar implementations. Additionally, a timing activation 230 implemented either in the form of a clock or timer is also contemplated as depicted in activation 230. This clock may be contained on the device 202, the security device or on the system 122. Other activation implementations contemplated by the present invention further include a dial-in activation 232 wherein a user 102 via the user transceiver 110 or other similar device contacts or dials the integrated transceiver 200, which interacts with the controller 210. In such an embodiment, the controller 210 may monitor audio signals originating from the user 102, which would otherwise be presented to the speaker 208 of the integrated transceiver 200 but are rather routed via an interface 234 to the controller 210 in the form of, for example, DTMF tones or similar key pad tones whose decoding and usage, are known by those of skill in the art. Such an activation keypad sequence may be decoded by the controller 210 for use in activation of the security device 106.

While the user 102 may rely upon the information provided via the detection sensors 212, and audible information from the microphone 206, a further embodiment of the present invention contemplates the inclusion of interrogation sensors 236 that may take the form of image-creating peripherals such as cameras or other sensor devices even including temperature sensors for monitoring the safety of the environment about the security device 106, or other data-providing sensors such as security networks location data generating devices for use in interrogating mobile or in-transit security devices as well as other sensors, known by those of skill in the art. The security device 106 may optionally include a power module 238 for use in powering the transceiver 200 and the security module 202. Alternatively, the power module 238 may be externally provided to the security device 106. The power module 238 may include a battery or capacitor, or a combination of both. The battery or capacitor may be replaceable. The batter or capacitor may incorporate or be connected to a charger, or may be connected to a backup power source, or may be powered by the item being protected.

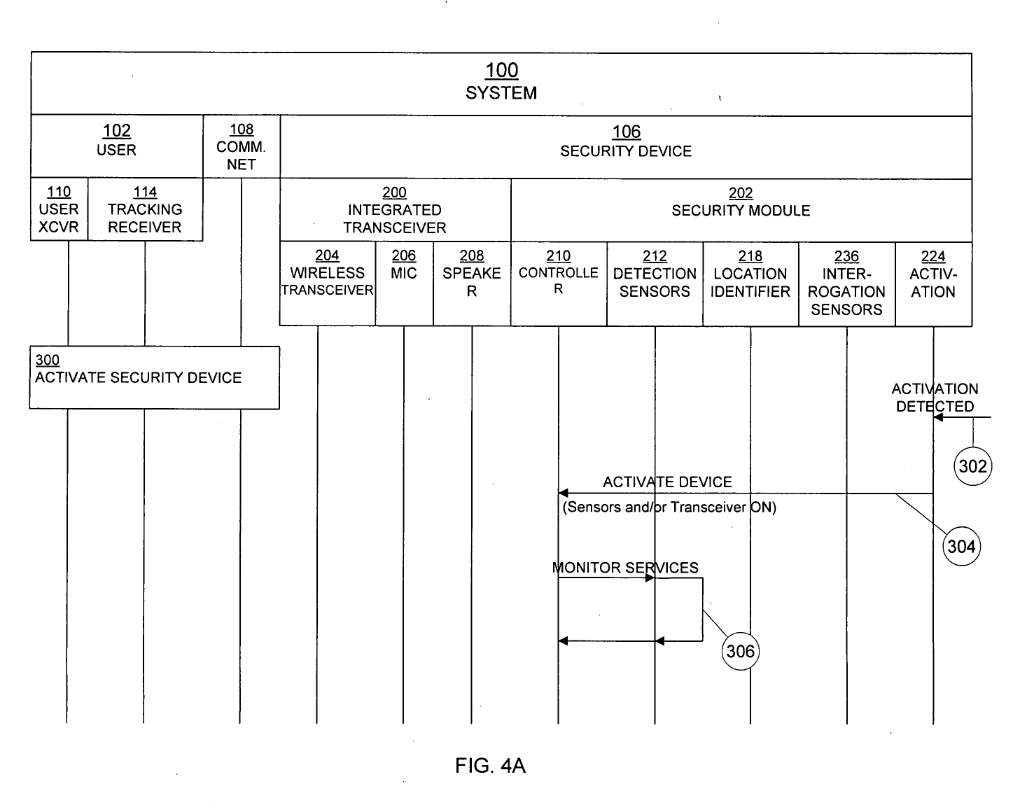

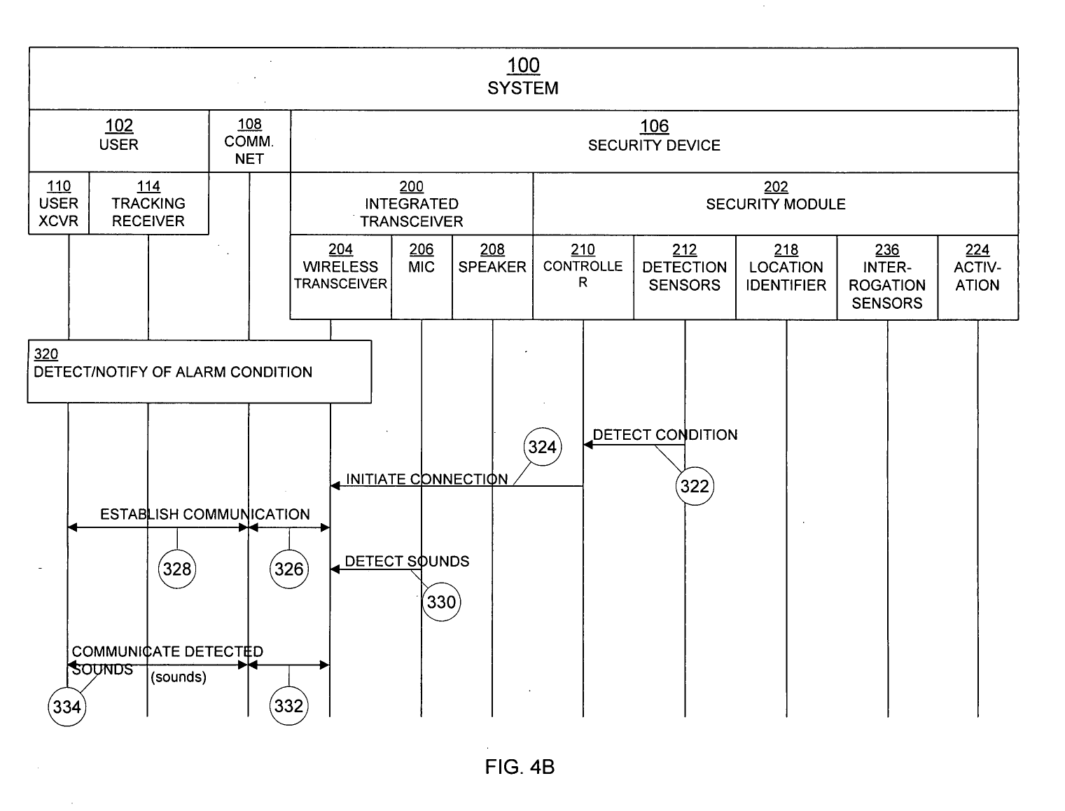

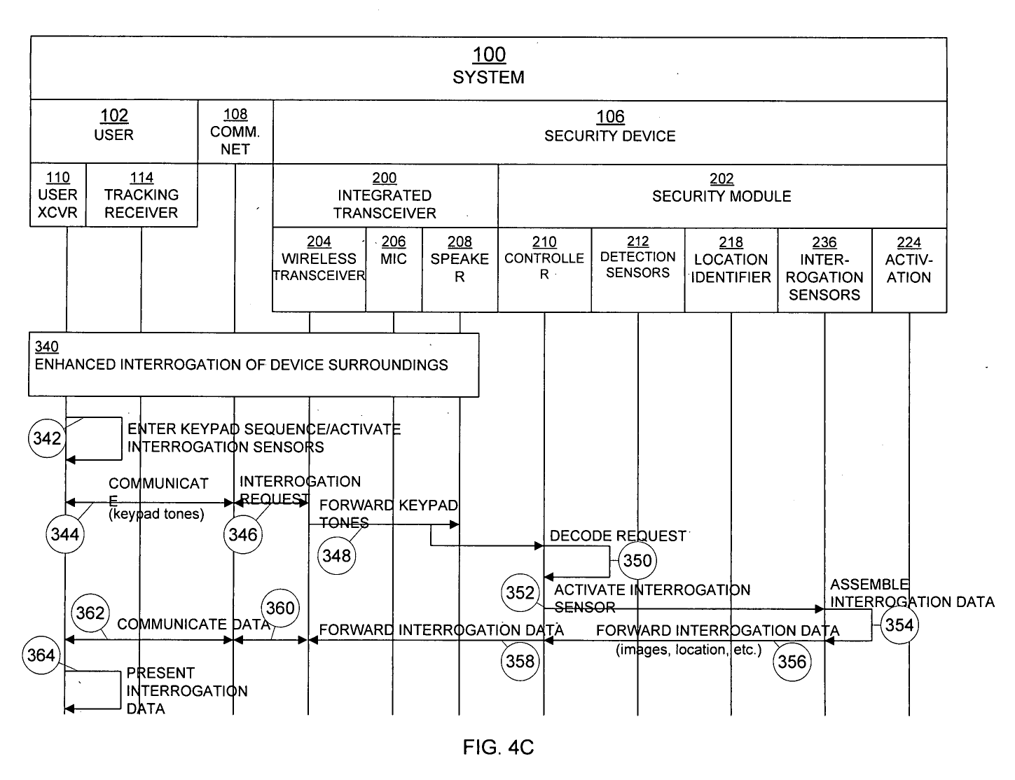

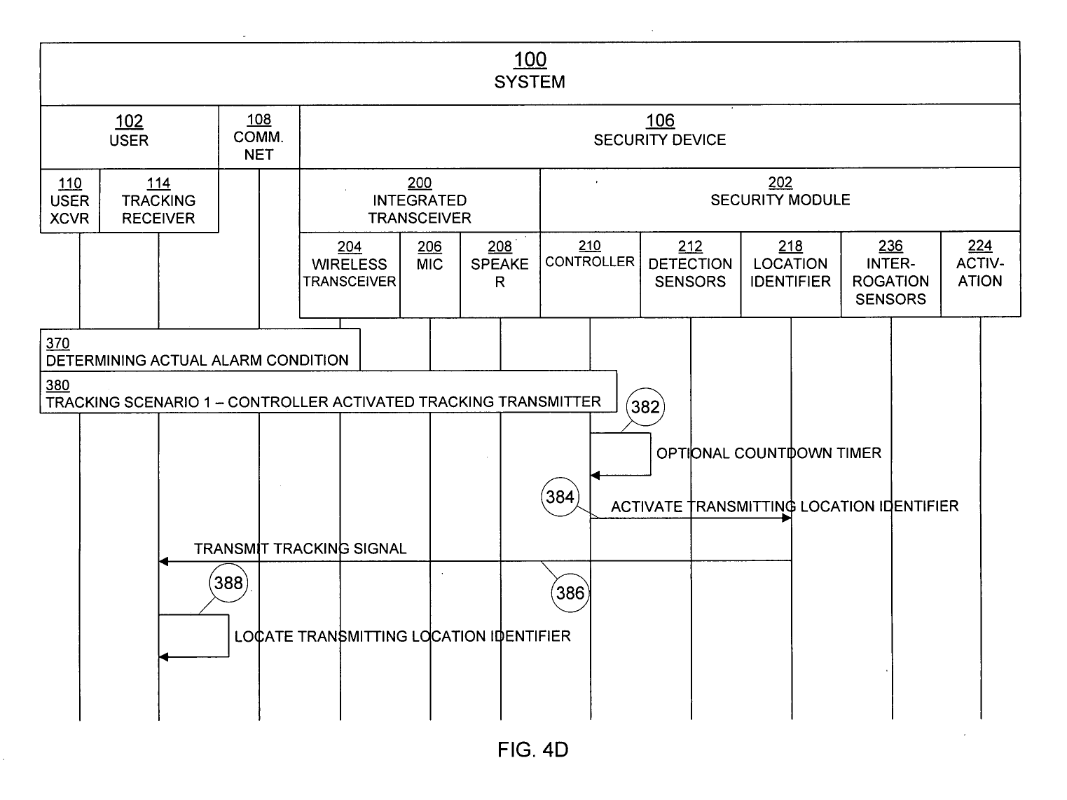

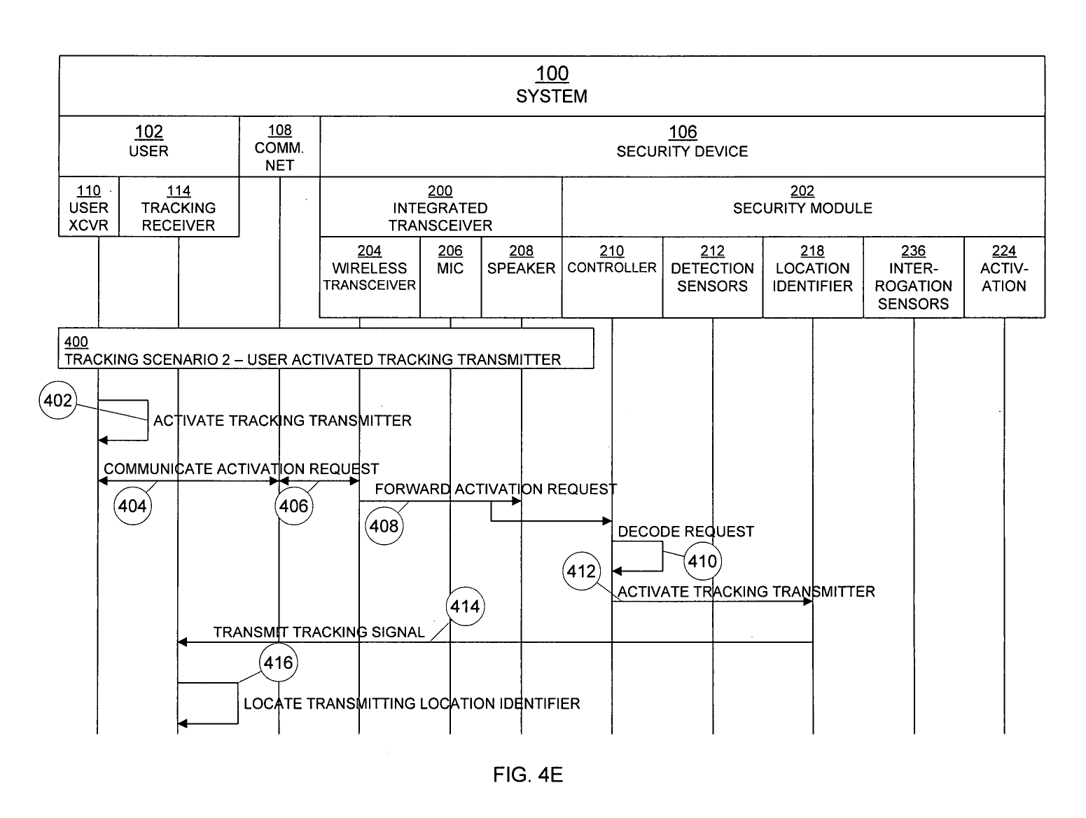

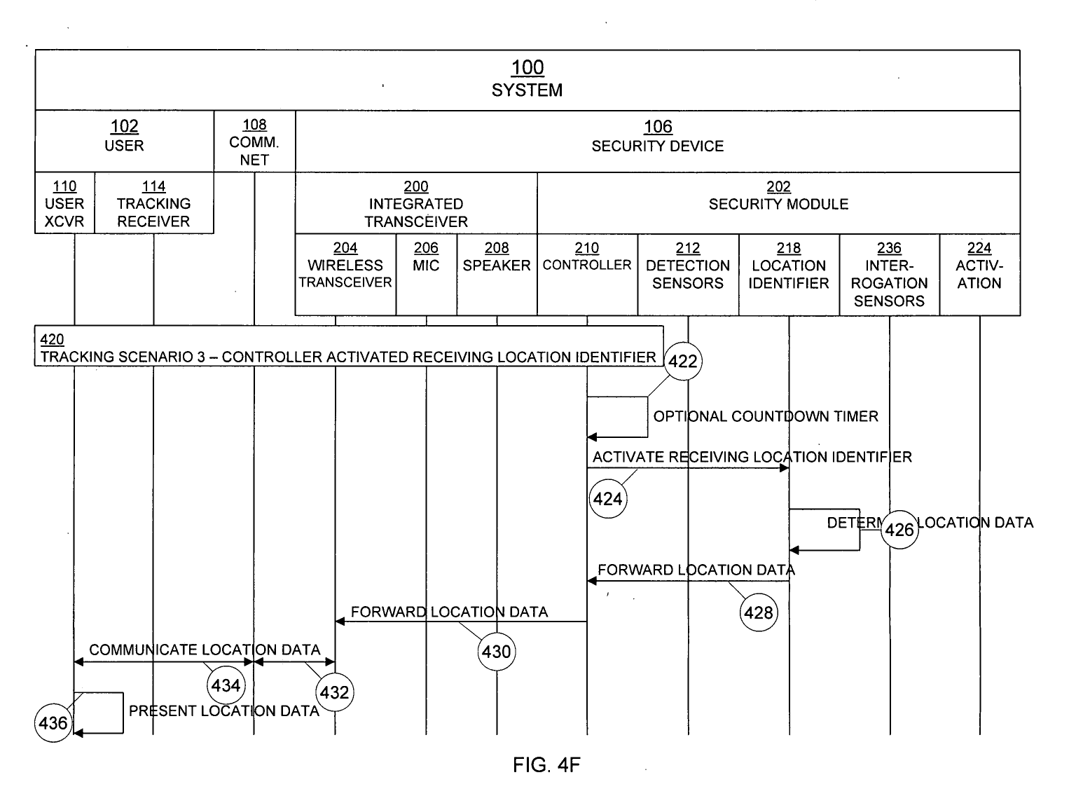

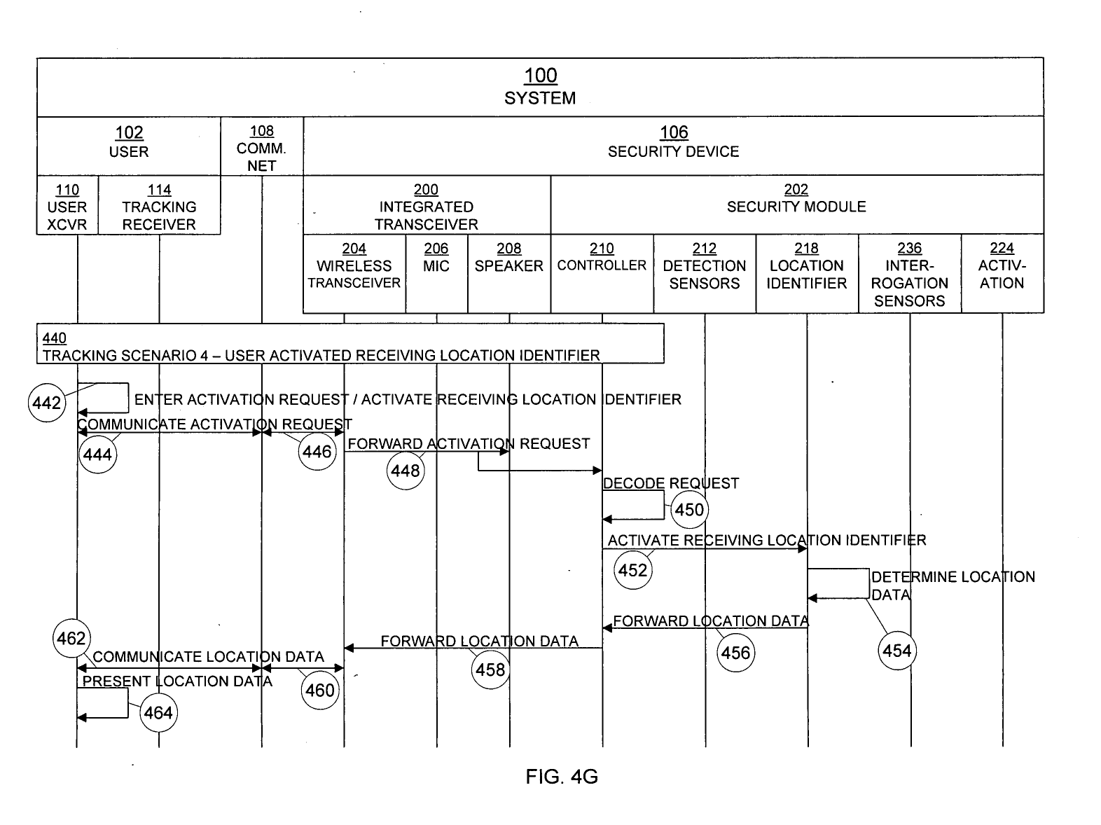

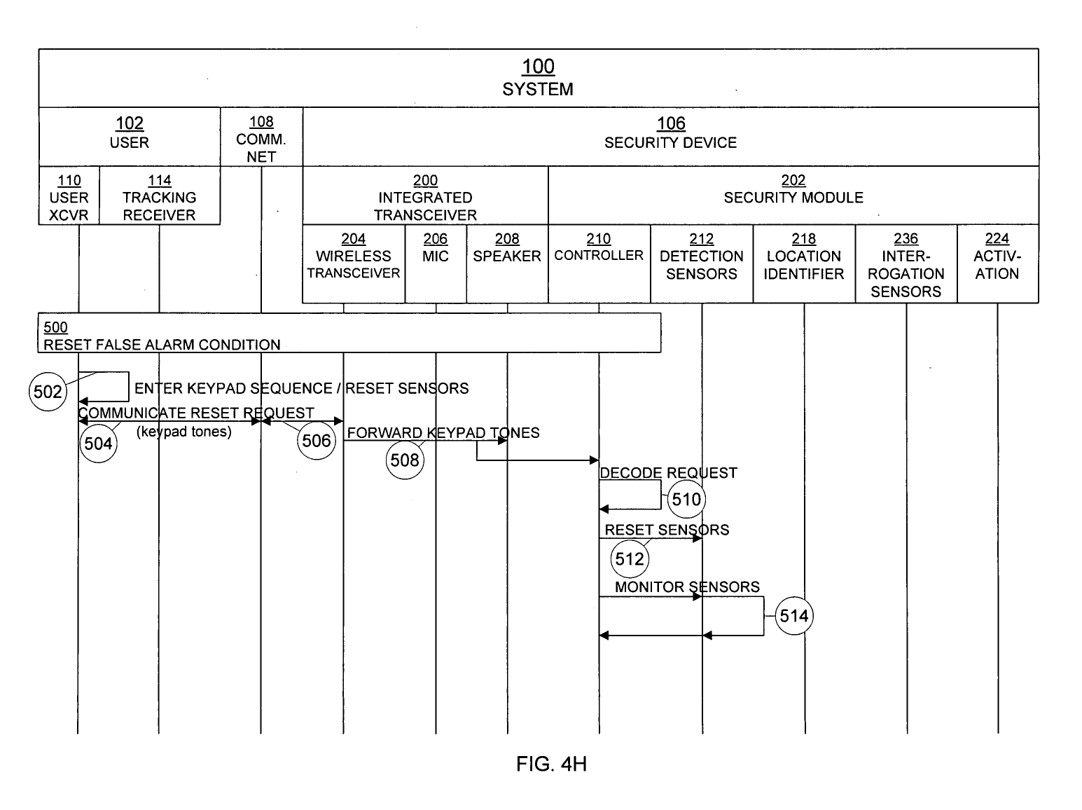

FIGS. 4A through 4H provide flowcharts of the operational steps, in accordance with an embodiment of the present invention. Referring to FIG. 4A, a procedure 300 illustrates activation of the security device 106. As described above, activation may occur according to various means. A step 302 depicts such an activation event received by the activation module 224, which may be included within the controller 210 as software or other procedural devices or may be externally generating an interrupt or other signal to the controller 210, as depicted in activate device step 304. In the step 306, the sensors 212 are activated and continue in a continuous monitoring state and may be implemented as the sensors 212, which assume autonomous monitoring and generate an interrupt to the controller 210 or may be periodically polled by the controller 210.

Referring to FIG. 4B, a procedure 320 illustrates detection and notification of an alarm condition. In the procedure 320, a detect condition 322 is generated either by the sensor 212 or identified by the control 210 in a polling arrangement. The controller 210 initiates a data or voice connection request to the wireless transceiver 204 in a step 324. The wireless transceiver 204 establishes a communication link in steps 326 and 328 via the communication network 108 to a user transceiver 110 or computing device 116. Once such a communication link is established, the microphone 206 may detect and forward sounds or audible tones or other condition information to the wireless transceiver 204 in a step 330. Detected or audible signals are thereafter passed across the communication link in steps 332 and 334 to the user transceiver 110 or computing device 116. The user thereafter may evaluate received information and determine appropriate action.

Alternatively, referring to FIG. 4C, a user 102 in a procedure 340, may elect to undertake enhanced interrogation of the device 106 surroundings in an attempt to better determine whether the sensor detected condition requires emergency intervention. As described above, enhanced or interrogation sensors may be integrated with the security device 106 to provide enhanced conditions such as imagery, infrared detection, or other desirable conditions helpful to a user in evaluating the surroundings about the security device 106. To initiate enhanced interrogation, the present invention contemplates a user 102 in a step 342 initiates a logic sequence, for example, through the use of a keypad sequence that generates a decodable sequence, for example, DTMF tones, or through one or more data packets provided by the computing system 122 communicating by means of the communication network 108. The logic sequence is transferred from the user transceiver 110 or computing device 116 to the wireless transceiver 204 via steps 344 and 346 over the communication link 108 either originally established as initiated by the detection of a sensor or through a user initiated communication link 108.

After initial detection and notification of an alarm condition in procedure 320 or after further enhanced interrogation in procedure 340, a user may determine whether or not a sensed alarm condition is an actual alarm condition as described in procedure 370 (see FIG. 4D) or a false alarm condition as described below in procedure 500 (see FIG. 4H). When a user determines or elects to declare the alarm condition as an actual alarm condition, various tracking scenarios may ensue. Several tracking scenarios are illustrated in FIGS. 4A through 4H and described below.

In procedures 380 (see FIG. 4D), a tracking scenario is illustrated wherein the security device 106 initiates activation of the location identifier 218, which assumes a tracking transmitter configuration. In a controller 210 activation scenario, a step 382 illustrates an optional countdown timer wherein the controller, upon the detection of a triggering event from the detection sensors 212, delays the activation for a period of time allowing the user to evaluate and perhaps further interrogate sensors before activating the tracking signal 112. Upon expiration of the optional countdown timer, the controller 210, in a step 384, activates the transmitting location identifier 218. The location identifier 218, in a step 386, transmits the tracking signal 112, which is detected by a user or other entity utilizing a tracking receiver 114. The tracking receiver 114, in a step 388, locates the transmitting location identifier 218, thus concluding tracking scenario 380.

An alternate tracking scenario is illustrated as procedure 400 (see FIG. 4E) which also employs a location identifier 218 implemented as a tracking transmitter. However, in this scenario, the tracking transmitter is activated by the user upon determination that the alarm is in fact an actual alarm rather than a false alarm. In procedure 400, a user enters a keypad sequence or encodes an activation request using computing device 116, in a step 402, which is communicated to the wireless transceiver 204 in steps 404 and 406. The wireless transceiver 204, in step 408, forwards the keypad sequence or activation request to the controller 210 whereupon the controller 210, in a step 410, decodes the keypad tone sequence or activation request and determines the user 102 requested course of action. Upon decoding, the controller 210, in a step 412, activates the transmitting location identifier 218 which in turn, in a step 414, broadcasts or transmits the tracking signal 112 to the tracking receiver 114. In a step 416, the tracking receiver 114 locates the transmitting location identifier 218, thus concluding procedure 400.

In yet another tracking scenario depicted as procedure 420 (see FIG. 4F), a location identifier 218 is implemented as a receiving location identifier that receives signals and determines a location based upon received signals. As described above, the location identifier 218 may be activated by a controller in a step 422, which employs a countdown or delay timer that postpones activation of portions of the circuitry that traditionally require an appreciable amount of power in their operation. In a step 424, the controller 210 activates the receiving location identifier 218 whereupon in a step 426 the location identifier 218 receives the signals 222 (see FIG. 3) and makes a determination or an assembly of location data for forwarding in step 428 back to the controller 210. The location data is further forwarded in steps 430 to the wireless transceiver 204, and further in steps 432 and 434 over the communication network 108 to the user transceiver 110 or computing device 116. In a step 436, the location data is presented to a user for interpretation, thus concluding tracking scenario 420.

In yet another tracking scenario depicted as procedure 440 (see FIG. 4G), a user activates the receiving location identifier 218 through a keypad sequence or activation request sent by means of the computing system 122. In a step 442, a user enters a keypad sequence or activation request of the location identifier 218. In steps 444 and 446, the activation request is communicated over a communication network 108 to the wireless transceiver 204. The wireless transceiver 204 forwards in step 448 the activation request to the controller 210, which in step 450 decodes the activation request and determines that activation is requested. In step 452, the controller 210 activates the receiving location identifier 218 whereupon the location identifier 218 determines location data in a step 454. In a step 456, the location identifier 218 forwards location data to the controller 210, which further relays the location data in a step 458 to the wireless transceiver 204. Over the communication network 108, the location data is forwarded in steps 460 and 462 to the user transceiver 110 or computing device 116. Following which, in a step 464, the user is presented with the location data for evaluation and determination of the location of the security device 106, thus concluding the tracking scenario 440.

As described above, a user when notified of an alarm condition may determine that such alarm condition is in fact benign and was generated either as the result of inadvertent sensor activation or as a result of overly sensitive sensors or transient alarm conditions acceptable to the user. Procedure 500 (see FIG. 4H) depicts the steps associated with the evaluation following determination of a false alarm condition. In a step 502, in response to the determination of a false alarm condition, the user enters a keypad sequence or reset request to reset the tripped or triggered sensors. The reset request is relayed over the communication network 108 in steps 504 and 506 to the wireless transceiver 204. In a step 508, the wireless transceiver 204 forwards the keypad tones to the controller 210, whereupon in a step 510 the controller decodes the reset request and determines that the user has requested that the sensors be reset. The controller 210, in a step 512, initiates reset of the sensors 212 whereupon the sensors, alternatively in conjunction with the controller 210, continues monitoring in a step 514.

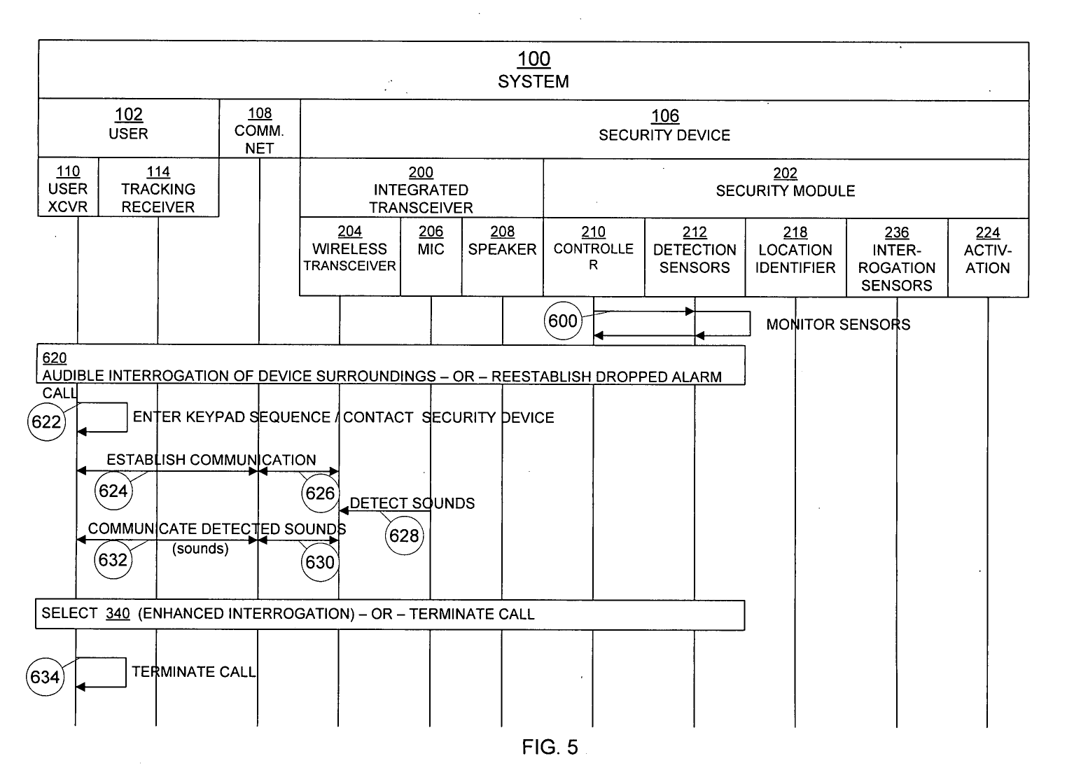

FIG. 5 illustrates a user-initiated interrogation of the device surroundings, in accordance with the present invention. The present invention contemplates a scenario where a user may initiate a contact with a security device 106 to evaluate the status of the security device 106 including any surrounding conditions perceivable to the security device 106. In such a scenario, the controller and sensors are undergoing monitoring in a step 600 representative of an activated sensor state described above. In a procedure 620, a user initiates the establishment of a communication link over the communication network 108 for one of various reasons, such as (i) the afore described desire by the user to evaluate the security device or its surroundings or (ii) to reestablish a dropped call which may have been initiated by the security device in response to detection sensor activation.

In a step 622, a user enters a keypad sequence or initiates a communication link to the security device 106. A communication link is established over the communication network 108 in steps 624 and 626. Once a communication link has been established between the user transceiver 110 or computing device 116 and the wireless transceiver 204, a sensor such as the microphone 206 detects sounds, in a step 628, and forwards those sounds/data, in steps 630 and 632, to the user transceiver 110 or computing device 116 for perception and evaluation by the user 102. Should the user desire enhanced interrogation, the user may proceed to query the interrogation sensors 236 according to the procedure 240 described above. When a user concludes audible interrogation and any optional enhanced interrogation, the user terminates the call in a step 634 and the system resumes its monitoring state. Alternatively, when a communication link is established, the user deactivates the sensors 212 or performs other controlling functions relating to the security device through the use of a keypad sequence or communications link, such as placing security device into a standby or inactive state.

Another scenario may include automation by the security device 106. The security device 106 could be used to activate or deactivate, depending on conditions detected in the vicinity of the security device 106, one or more other devices such as lights, heaters, sounding devices, relays, switches, detectors or other electromechanical devices.

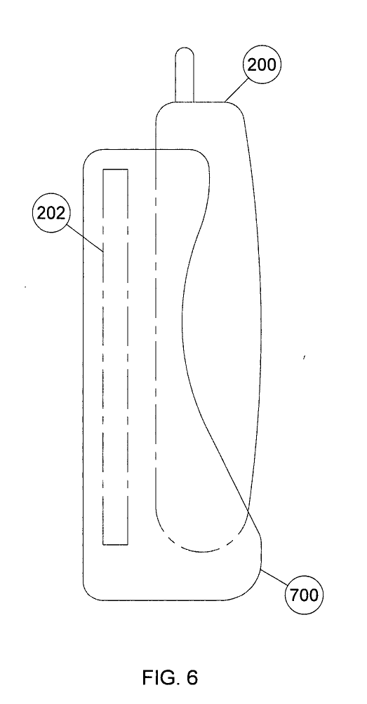

FIG. 6 illustrates a mechanical arrangement of an integrated transceiver 200 being received within a housing 700 that includes a security module 202 and the associated mechanical coupling of the integrated transceiver 200. The integrated transceiver 200 assumes a generally integrated handset form-factor providing transceiver functionality as described above in relation to the wireless transceiver 204 and further includes the microphone 206 and speaker 208 with the general interfaces 214 and 234 (see FIG. 3).

Also illustrated in FIG. 6 is a housing 700 that generally attaches or receives the integrated transceiver 200, which in one exemplary embodiment receives the integrated transceiver 200 and electrically mates with exposed electrical contacts (e.g., hands-free or modem-coupling interfaces) for coupling with a security module 200 integrated within the housing 700. It should be appreciated that the housing 700 may mate with the integrated transceiver in either a “holster-like” receiving arrangement or snap or otherwise couple to the back either over or instead of the battery portion of the integrated handset. Those of skill in the art appreciate other mounting and interfacing techniques that may equally provide coupling of the security module with the integrated transceiver. Such additional coupling alternatives are contemplated within the scope of the present invention. Other couplings may include additional sensors not originally contained in the security device 106, but that are provided as “add-ons” such as smoke, chemical, or radiation sensors, or other sensors such as cameras.

While the present illustration contemplates an integrated transceiver, it is also contemplated that general transceiver functionality may be provided in a “raw” circuit board configuration to be further packaged in another form-factor exhibiting similar functionality. Also contemplated is an embodiment that integrates the transceiver functionality and the security module functionality into a single integrated device. Further contemplated is an embodiment that is integrated within a larger assembly, such as a vehicle or other device, wherein the control functionality such as an on-board computer may be utilized to provide controller functionality and share yet other sensors, transceivers and the like.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

1. A mobile monitoring device comprising:
a controller;
a transceiver in communication with the controller, the transceiver capable of communicating with a computing device;
at least one sensor in communication with the controller, wherein the sensor is monitoring a condition of the property or a condition proximate to the monitoring device; and
a communication interface in communication with the controller and the transceiver, the communication interface configured to provide information that may be transmitted to the computing device by the transceiver.

2. The mobile monitoring device of claim 1 wherein the monitoring device is configured to execute programming commands received from the computing device.

3. The mobile monitoring device of claim 1 wherein the communication interface comprises a web service.

4. The mobile monitoring device of claim 1 further comprising a microphone that is configured to gather the sounds proximate to the monitoring device.

5. The mobile monitoring device of claim 1 further comprising a camera that is configured to view the area proximate to the monitoring device.

6. The mobile monitoring device of claim 1 wherein the sensor comprises at least one a motion sensor, a shock sensor, an audible/sound sensor, a humidity sensor, a fire sensor, a temperature sensor, a detachment sensor, a motion sensor, a smoke sensor, a video sensor, a magnetic sensor, a freezing sensor, an overheating sensor, a weight sensor, a chemical sensor, a radiation sensor, a glass break sensor, an intrusion sensor, a carbon monoxide sensor, a poison sensor, a vibration sensor, and a light sensor.

7. The mobile monitoring device of claim 1 further comprising a low-battery sensor, a primary battery, and a secondary battery.

8. The mobile monitoring device of claim 1 further comprising an RF transmitter.

9. The mobile monitoring device of claim 1 further comprising a GPS device.

10. The mobile monitoring device of claim 1 further comprising a receptor that allows the monitoring device to communicate with an external security device.

11. The mobile monitoring device of claim 1 further comprising a speaker, and wherein the monitoring device is configured to play audible sounds on the speaker received from the transceiver to allow a user to transmit audible sounds to the area proximate to the monitoring device.

12. The mobile monitoring device of claim 1 further comprising an alarm system.

13. The mobile monitoring system of claim 12 wherein the alarm system comprises a siren.

14. The mobile monitoring device of claim 1 further comprising lights configured to illuminate the area proximate to the monitoring device.

15. The mobile monitoring device of claim 1 further comprising an information storage unit.

16. The mobile monitoring device of claim 1 further comprising an interrupt controller.

17. A mobile monitoring device for monitoring property comprising:
a controller;
a transceiver in electronic communication with the controller, the transceiver capable of communicating with a computing device;
a plurality of sensors in electronic communication with the controller, the sensors configured to monitor a change in a condition of the property; and
a communication interface that is in electronic communication with the controller and the transceiver, the communication interface comprising a web service that is configured to provide information that may be transmitted to the computing device by the transceiver, wherein the monitoring device is further configured such that it is capable of executing programming commands received from the computing device.

18. A method of improving security of property using a mobile programmable monitoring device comprising a controller, a transceiver capable of communicating with a computing device, at least one sensor, and a communications interface in electronic communication with the controller and the transceiver, the method comprising:
monitoring a condition of the property with the programmable monitoring device;
contacting the computing device with the transceiver if the monitoring device detects a change in a condition of the property; and
providing information related to the condition of the property that is transmitted to the computing device by the transceiver.

19. The method of claim 18 further comprising the step of activating a tracking transmitter to facilitate locating the monitoring device.

20. The method of claim 18 further comprising the step of executing a programming command received from the computing device.

21. The method of claim 18 further comprising the step of sending a confirmation to the computing device to confirm that the programming command has been executed.

22. The method of claim 18 wherein the programming command is a command to activate or deactivate a sensor.

23. The method of claim 18 wherein the programming command is a command to activate or deactivate an alarm.

24. The method of claim 18 wherein the programming command is a command to reset the monitoring device.

25. The method of claim 18 wherein the programming command is a command to turn the monitoring device on or off at a selected time.

26. The method of claim 18 wherein the programming command is a command to activate or deactivate an electrical or electromechanical device.

27. The method of claim 18 wherein the programming command is a command to activate or deactivate a camera.

28. The method of claim 18 wherein the programming command is a command that activates or deactivates a sequence of commands.

29. The method of claim 18 further comprising the step of verifying a password prior to providing information to the computing device.

30. The method of claim 18 further comprising the step of reviewing the information provided to the computing device.

31. A method for programming a programmable mobile monitoring device comprising a controller, a transceiver capable of communicating with a computing device, at least one sensor, and a communications interface in electronic communication with the controller and the transceiver, the method comprising:
contacting the programmable mobile monitoring device with the computing device;
establishing communication between the computing device and the monitoring device; and
using the computing device to issue a programming command that may be executed by the monitoring device.

32. The method of claim 30 further comprising the step of sending a confirmation to the computing device to confirm that the programming command has been executed.

33. The method of claim 30 wherein the monitoring device further comprises at least one input device, the monitoring device further comprising an information storage unit that is capable of storing information gathered by the at least one sensor and the at least one input device.
